(19) United States
(12) Patent Application Publication
(10) Pub. No.: US 2010/0188686 A1
(43) Pub. Date: Jul. 29, 2010

(54) IMAGE FORMING APPARATUS, CONTROL METHOD FOR IMAGE FORMING APPARATUS, AND IMAGE FORMING SYSTEM

(75) Inventor: Michiaki Konno, Kanagawa (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/695,488

(22) Filed: Jan. 28, 2010

Related U.S. Application Data
(60) Provisional application No. 61/148,187, filed on Jan. 29, 2009.

(51) Int. Cl. G06K 15/00

(52) U.S. Cl. 358/1.14

(57) ABSTRACT

An image forming apparatus according to the invention has a system control unit provided in a body unit having an image forming unit. The system control unit controls the image forming unit and outputs a power off command to the body unit including the system control unit itself if it is determined that a preset power-saving mode transition condition is met. The image forming apparatus has an authentication data reading device which receives supply of power from a power supply path that is different from a power supply path to the body unit, reads authentication data from an authentication medium, and holds the read data. Moreover, the image forming apparatus has a power control unit which turns off the power supply path to the body unit in accordance with the power off command outputted from the system control unit, and turns on the power supply path to the body unit as the authentication data reading device reads the authentication data from the authentication medium.

### CROSS-REFERENCE TO RELATED APPLICATION

This application is based upon and claims the priority of U.S. Provisional Application No. 61/148,187, filed on Jan. 29, 2009, the entire contents of which are incorporated herein by reference.

### TECHNICAL FIELD

The present invention relates to an image forming apparatus used as a copier, laser printer or the like having a power-saving mode, a control method for the image forming apparatus, and an image forming system.

### BACKGROUND

An image forming apparatus such as a copier or laser printer has a power-saving mode in which power supply is partially stopped if the apparatus is not in use for a predetermined time. If the image forming apparatus is shared in office or the like, permission to use the apparatus may be given on the basis of personal authentication. For example, each user may be identified by user ID or the like and the use may be limited only to users who are correctly identified. Thus, unauthorized use by outsiders can be prevented.

In the case of giving permission to use based on person authentication, the power source on the system side must be constantly on in order to authenticate users even in the state of power-saving mode and there is a limit to power-saving.

For example, in an image forming apparatus disclosed in JP-A-2006-218810, input of user ID is enabled by supplying power to a wireless communication unit for receiving user information and an operation panel. Thus, even in the state of power-saving mode, the power source on the system side including the operation panel cannot be totally turned off and power-saving effects are limited.

### SUMMARY

An object of the invention is to provide an image forming apparatus in which the off-range of the power source in the power-saving mode is expanded to improve power-saving effects, a control method for this image forming apparatus, and an image forming system.

According to an aspect of the invention, an image forming apparatus includes: a body unit which has an image forming unit;an authentication data reading device which reads authentication data from an authentication medium; a system control unit which is provided in this body unit, and outputs a order to interrupt a power supply to the body unit if it is determined that a preset condition for transiting power-saving mode is met;and a power control unit which interrupts the power supply to the body unit and the system control unit in accordance with the order to interrupt the power supply outputted from the system control unit, and restarts the power supply to the body unit and the system control unit if the authentication data reading device reads the authentication data from the authentication medium.

a body unit having an image forming unit; a system control unit which is provided in this body unit, controls the image forming unit, and outputs a power off command to the body unit including the system control unit itself if it is determined that a preset power-saving mode transition condition is met; an authentication data reading device which receives supply of power from a power supply path that is different from a power supply path to the body unit, reads authentication data from an authentication medium, and holds the read data; and a power control unit which turns off the power supply path to the body unit in accordance with the power off command, outputted from the system control unit, and turns on the power supply path to the body unit as the authentication reading device reads the authentication data from the authentication medium.

### DESCRIPTION OF THE DRAWINGS

FIG. 1 is a block diagram showing the system configuration of an image forming apparatus according to a first embodiment of the invention;

FIG. 2 is a flowchart for explaining the operation of the image forming apparatus according to the first embodiment of the invention; and

FIG. 3 is a schematic view of the configuration of an authentication data reading device according to the first embodiment of the invention.

### DETAILED DESCRIPTION

Hereinafter, an embodiment of the invention will be described in detail with reference to the drawings.

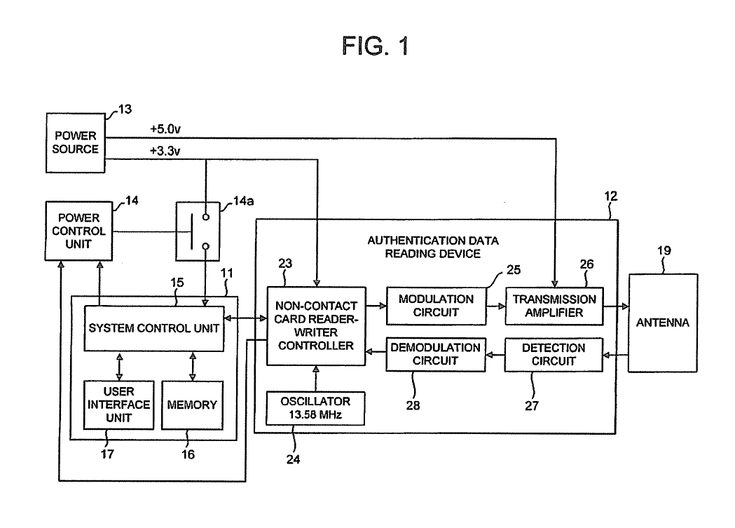

FIG. 1 shows an image forming apparatus according to the embodiment of the invention. This image forming apparatus has a schematic configuration including a body unit 11, an authentication data reading device 12, a power source 13 for the body unit 11 and the authentication data reading device 12, and a power control unit 14.

The body unit 11, though not shown, has a scanner unit and a paper discharge unit in an upper part and has an image forming unit inside. The image forming unit, in the case of a color copier, has a laser exposure device, four sets of image forming stations including yellow (Y), magenta (M), cyan (C) and black (K), a developing device, an intermediate transfer belt, a secondary transfer roller which transfers a color image on the intermediate transfer belt to a paper sent from a paper supply cassette, and so on. That is, each image forming station has a photoconductive drum and an electrostatic latent image is formed on the surface of the photoconductive drum by the laser exposure device. The developing device supplies a toner to the electrostatic latent image and forms an image in each color. The image in each color is carried on the intermediate transfer belt and then transferred onto the paper by the secondary transfer roller. Thus, a color image is formed.

The body unit 11 is also provided with a system control unit 15, a memory 16, and a user interface 17, as shown in FIG. 1. The system control unit 15 controls the above image forming unit according to a preset program, using various data stored in the memory 16 and instruction information inputted from the user interface 17. The system control unit 15 also performs transition control to a power-saving mode when a preset power-saving mode transition condition is met. The system control unit 15 also executes authentication data processing to determine whether authentication data inputted from the authentication data reading device 12 should be approved or not.

The memory 16 stores a control program for the system control unit 15 and various data used for the control program, and also temporarily stores data generated in the process of executing the control program. The user interface unit 17 is a so-called control panel. The user interface unit 17 enables users to input various instruction data and setting data and enables various output data from the system control unit 15 to be displayed.

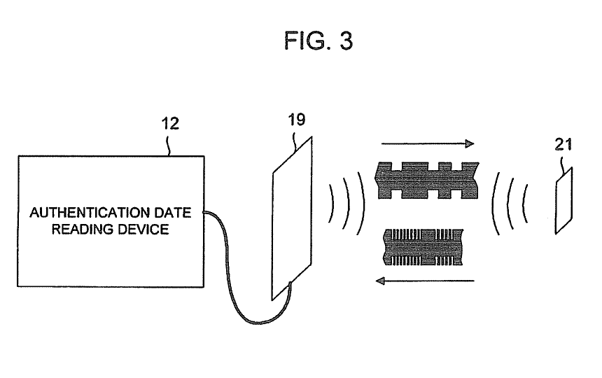

The authentication data reading device 12 has an antenna 19. Via this antenna 19, the authentication data reading device 12 sends radio waves to an authentication medium 21 and receives radio waves sent back from the authentication medium, thereby reading authentication data from the authentication medium 21 in a non-contact manner, as shown in FIG. 3. The authentication data reading device 12 also has the function of holding the read data. That is, this authentication data reading device has a non-contact card reader-writer controller (hereinafter referred to as reader-writer controller) 23, an oscillator 24, a modulation circuit 25, a transmission amplifier 26, a detection circuit 27, and a demodulation circuit 28. The reader-writer controller 23 sends a read command from the antenna 19 via the modulation circuit 25 and the transmission amplifier 26 on the basis of the oscillation frequency from the oscillator 24. This read command is received by the authentication medium 21 existing near the antenna 19. The authentication medium 21 sends back corresponding authentication data. The authentication data that is sent back is received by the antenna 19 and inputted to the reader-writer controller 23 via the detection circuit 27 and the demodulation circuit 28. The reader-writer controller 23 saves the inputted authentication data and outputs an authentication data detection signal indicating that the authentication data is inputted, to the power control unit 14.

As the authentication medium 21, for example, an RFID (radio frequency identification) card (hereinafter also referred to as non-contact card) is used.

The power source 13 is for supplying power to the body unit 11 and the authentication data reading device 12 and outputs a power of +5.0 v and +3.3 v. Of these, the power of +5.0 v is supplied to the transmission amplifier 16 of the authentication data reading device 12, and the power of +3.3 v is supplied to the system control unit 15 of the body unit 11 and the reader-writer controller 23 of the authentication data reading device 12.

The power control unit 14 is for performing on-off control of a switch 14a provided in a power supply path to the system control unit 15 of the body unit 11. The power control unit 14 turns off the switch 14a in accordance with a power off command that is outputted when the transition control to the power-saving mode is performed by the system control unit 15.

The body unit 11 is provided with the image forming unit as described above. This image forming unit is supplied with power from another power source, not shown. A similar switch is provided in a power supply path to the image forming unit, and the power control unit 14 also turns off the switch provided in the power supply path to the image forming unit under the same condition (the transition control to the power-saving mode). Therefore, as the system control unit 15 performs the transition control to the power-saving mode, the power control unit 14 turns off the switch 14a and therefore the power supply to the body unit 11 is totally shut down.

Meanwhile, the power supply path to the authentication data reading device 12 does not have the switch 14a that is turned off by the power control unit 14. Therefore, even if the power supply to the body unit 11 is totally shut down by the transition control to the power-saving mode by the system control unit 15, the power supply to the authentication data reading device 12 continues. Thus, data reading from the authentication medium 21, holding of the read authentication data, and output of an authentication data detection signal are maintained even in the power-saving mode.

As the authentication data reading device 12 reads authentication data from the authentication medium 21 and an authentication data detection signal is thus outputted from the authentication data reading device 12, the power control unit 14 turns on the switch 14a and turns of the power supply path to the body unit 11. That is, as the authentication data reading device 12 reads authentication data from the authentication medium 21, the power-saving mode is canceled and the power supply to the system control unit 15 is resumed. When the power source is turned on, the system control unit 15 inputs the authentication data held by the authentication data reading device 12 and determines whether the data allows log-in or not. If the data allows log-in as a result of the determination, the image forming unit is made available.

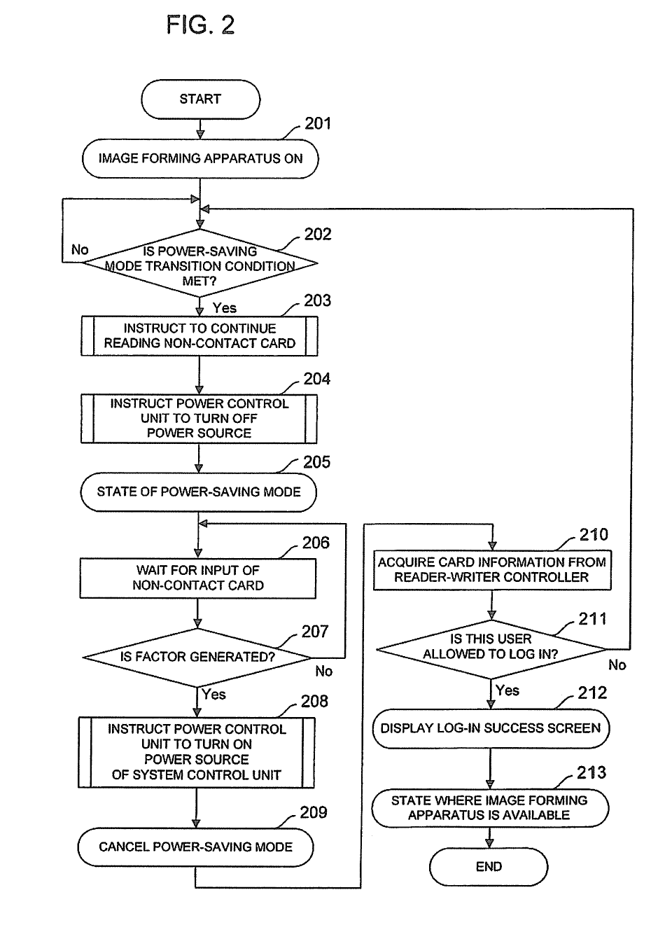

Next, the operation of the above embodiment will be described with reference to the flowchart of FIG. 2.

It is now assumed that the image forming apparatus is in normal use (ACT 201). In this state, it is determined whether the power-saving mode transition condition is met or not (ACT 202). The power-saving mode transition condition refers to, for example, a condition that there is no response from the control panel, the platen cover or the like within a preset time. When such a condition is met (Yes in ACT 202), the system control unit 15 executes transition control to the power-saving mode. That is, the system control unit 15 first instructs the authentication data reading device 12 to continue reading authentication data from the non-contact card as the authentication medium 21 (ACT 203). Next, the system control unit 15 instructs the power control unit 14 to turn off power (ACT 204).

As this transition control to the power-saving mode is executed, the switch 14a is turned off, the power supply to the body unit 11 is shut down, and the image forming apparatus enters the state of power-saving mode (ACT 205). That is, when the image forming apparatus is in the state of power-saving mode, the system control unit 15 is off and only the power source of the authentication data reading device 12 remains on.

In this state of power-saving mode, the authentication data reading device 12 is in the state of waiting for input from the non-contact card 21 (ACT 206). In this state, if the non-contact card 21 is held over the antenna 19 of the authentication data reading device 12 (ACT 207), the reader-writer controller 23 of the authentication data reading device 12 outputs an authentication data detection signal and sends a signal to the power control unit 14 so that the power source of the system control unit 15 is turned on (ACT 208). Consequently, the power control unit 14 turns the switch 14a on to resume the power supply to the system control unit 15, and the power-saving mode is thus canceled (ACT 209).

After the power-saving mode is canceled, the system control unit 15 acquires authentication data (card information) held by the reader-writer controller 23 (ACT 210). Here, the reader-writer controller 23 of the authentication data reading device 12 continues to hold the read data (authentication data) even in the state of power-saving mode as described above. Therefore, if the power-saving mode is canceled and shifted to the normal mode, the system control unit 15 inputs the authentication data held on the reader-writer controller 23 and determines whether log-in should be allowed for this data or not (ACT 211). If the authentication data (user information) is the data of a user allowed to log in, log-in is executed and a “log-in success” screen is displayed (ACT 212). The image forming apparatus then becomes available (ready state) (ACT 213).

In this manner, when transition to the power-saving mode is made, the power supply to the authentication data reading device 12 is maintained but the power supply to all the other parts of the body unit 11 including the system control unit 15 is shut down. Therefore, sufficient power-saving effects can be achieved. Also, even in the state of power-saving mode where power to the system control unit 15 is turned off, if the non-contact card 21 as the authentication medium is held over the authentication data reading device 12, the power-saving mode is immediately canceled and the image forming apparatus starts up and performs authentication. Therefore, the image forming apparatus can be used immediately.

What is claimed is:

1. An image forming apparatus comprising:
a body unit which has an image forming unit;
an authentication data reading device which reads authentication data from an authentication medium;
a system control unit which is provided in this body unit, and outputs a order to interrupt a power supply to the body unit if it is determined that a preset condition for transiting power-saving mode is met;and
a power control unit which interrupts the power supply to the body unit and the system control unit in accordance with the order to interrupt the power supply outputted from the system control unit, and restarts the power supply to the body unit and the system control unit if the authentication data reading device reads the authentication data from the authentication medium.

2. The apparatus of claim 1, wherein the system control unit controls the image forming unit.

3. The apparatus of claim 1, wherein the authentication data reading device receives supply of power from a power supply path that is different from a power supply path to the body unit and the system control unit.

4. The apparatus of claim 3, wherein the authentication data reading device holds the authentication data read from the authentication medium in the power-saving mode.

5. The apparatus of claim 4, wherein the system control unit determines the authentication data held by the authentication data reading device allows log-in or not, after restart of the power supply to the body unit and the system control unit is restarted, and permits to use the image forming unit if the authentication data allows log-in.

6. The apparatus of claim 1, wherein the authentication data reading device is a non-contact data reading device which sends a radio wave to the authentication medium, then receives a radio wave sent back from the authentication medium, and thereby reads the authentication data from the authentication medium.

7. The apparatus of claim 1, wherein the authentication medium is an RFID card.

8. A control method for an image forming apparatus comprising:
if a system control unit provided in a body unit which has an image forming unit determines that a preset condition for transiting power-saving mode is met, outputting a order to interrupt power supply to the body unit;
interrupts a power supply to the body unit and the system control unit by a power control unit in accordance with the order to interrupt power supply outputted from the system control unit;
even after the power supply to the body unit and the system control unit is interrupted, reading authentication data from an authentication medium by an authentication data reading device; and
restarts the power supply to the body unit and the system control unit by the power control unit if the authentication data reading device reads the authentication data from the authentication medium.

9. The method of claim 8, wherein the system control unit controls the image forming unit.

10. The method of claim 8, wherein the authentication data reading device—receives supply of power from a power supply path that is different from a power supply path to the body unit and the system control unit.

11. The method of claim 8, wherein the authentication data reading device holds the authentication data read from the authentication medium in the power-saving mode.

12. The method of claim 11, wherein the system control unit determines authentication data held by the authentication data reading device allows log-in or not, after restart of the power supply to the body unit and the system control unit is restarted, and permits to use the image forming unit if the authentication data allows log-in.

13. The method of claim 8, wherein the authentication data reading device sends a radio wave to the authentication medium, then receives a radio wave sent back from the authentication medium, and thereby reads the authentication data from the authentication medium in a non-contact manner.

14. An image forming system comprising:
an authentication data reading device which reads authentication data from an authentication medium;
a system control unit which is provided in a body unit which has an image forming unit, and outputs a order to interrupt power supply to the body unit if it is determined that a preset for transiting power-saving mode is met; and
a power control unit which interrupts—the power supply to the body unit and the system control unit in accordance with the order to interrupt the power supply outputted from the system control unit, and restarts the power supply to the body unit and the system control unit if the authentication data reading device reads the authentication data from the authentication medium.

15. The apparatus of claim 14, wherein the system control unit controls the image forming unit.

16. The apparatus of claim 14, wherein the authentication data reading device receives supply of power from a power supply path that is different from a power supply path to the body unit and the system control unit.

17. The apparatus of claim 16, wherein the authentication data reading device holds the authentication data read from the authentication medium in the power-saving mode.

18. The system of claim 17, wherein the system control unit determines the authentication data held by the authentication data reading device allows log-in or not, after restart of the power supply to the body unit and the system control unit is restarted, and permits to use—the image forming unit if the authentication data allows log-in.

19. The system of claim 14, wherein the authentication data reading unit is a non-contact data reading unit which sends a radio wave to the authentication medium, then receives a radio wave sent back from the authentication medium, and thereby reads the authentication data from the authentication medium.

20. The system of claim 14, wherein the authentication medium is an RFID card.
